(19) United States
(12) Patent Application Publication
(10) Pub. No.: US 2015/0066769 A1
(43) Pub. Date: Mar. 5, 2015

(54) Method, Apparatus and System for Confirming Off-Line Customer Transactions

(71) Applicant: Joseph J. Tallal, JR., Dallas, TX (US)

(72) Inventor: Joseph J. Tallal, JR., Dallas, TX (US)

(21) Appl. No.: 14/477,852

(22) Filed: Sep. 4, 2014

Related U.S. Application Data
(60) Provisional application No. 61/873,702, filed on Sep. 4, 2013.

(51) Int. Cl. G06Q 20/32; G06Q 20/20; G06Q 20/40

(52) U.S. Cl. CPC G06Q 20/3224; G06Q 20/40; G06Q 20/20
USPC 705/44

(57) ABSTRACT

A method, apparatus or system confirms a customer transaction by using a computer having a processor, a memory and a communications interface. A transaction data generated by a point-of-sale device physically located at a merchant is received via the communications interface. The transaction data includes a merchant identifier, a first customer identifier, a transaction amount and a first date/time. A customer location data generated by a customer mobile device physically located at the merchant is received via the communications interface. The customer location data includes a second customer identifier, a location information and a second date/time. A customer transaction confirmation is generated whenever the transaction data matches the customer location data, and one or more actions are performed based on the customer transaction confirmation.

### CROSS-REFERENCE TO RELATED APPLICATIONS

This application claims priority to and is a non-provisional of U.S. provisional patent application Ser. No. 61/873,702 filed on Sep. 4, 2013 and entitled “System for the Development of an Off-line Affiliate Marketing Network”, which is hereby incorporated by reference in its entirety.

### INCORPORATION-BY-REFERENCE OF MATERIALS FILED ON COMPACT DISC

None.

### TECHNICAL FIELD OF THE INVENTION

The present invention relates in general to the field of computer systems and transaction processing, and more specifically to a method, apparatus and system for confirming off-line customer transactions.

### STATEMENT OF FEDERALLY FUNDED RESEARCH

None.

### BACKGROUND OF THE INVENTION

Without limiting the scope of the invention, its background is described in connection with the development of the Internet based Affiliate Marketing Industry.

For over a decade, online shopping has seen an exception rate of growth. Major retailer who at first saw the Internet as a threat to their business due to new online stores popping up that could undercut their prices due to a very lower overhead, have subsequently come to view the Internet as their salvation.

The fact is that the Internet offers a retailer the most cost effective way to interact with a customer, sell them products, and put those products in the customer's hands. This is because unlike a traditional retail store, which requires large capital outlay for real estate, electricity, property taxes, stocking, staffing, and pilferage; on-line stores only have the cost of the development of a single website, an automated ordering process, and warehouses that handle their fulfillment.

As retail shopping gained prominence on the Internet, merchants started looking for ways to drive more and more business to their websites. This created a new opportunity unto itself which developed into what is now known as the affiliate marketing industry (“AMI”).

The AMI fulfilled two important needs on Internet. The first was helping retailers to drive new customers to their sites; and the second was to help monetize existing websites with large audiences that were having trouble finding ways to earn money from their website (such as bloggers, news services, informational sites, etc.).

The way that AMI worked was that a website owner with high traffic volume could publish an ad for a merchant on their site that when clicked would send that site's visitor to the retailer's on-line store. In turn, the retailer would pay the website owner a fee or commission for sending this potential customer to them.

In the beginning, this took the form of a pay per click revenue model where the retailer would pay for every click through on their ad. However, this soon led to an issue of not being able to control the quality of the click throughs as many were not real potential purchasers.

This process later evolved into a pay per sale method where the retailer paid a sales commission when something was actually bought by a customer on that visit. This most often took the form of a percentage amount of the total sales transaction, but could also be a one-time fixed fee when purchases were for monthly services like wireless phone service, cable and satellite service, web hosting, etc.

This new concept left one glaring issue which needed to be resolved. That issue was how to ensure the website owner that it would actually be paid fairly based on purchases made by its people, as it had no way to track what happened after it delivered these prospective customers to the merchant's site.

The solution became the development of companies that acted as third party intermediaries to track and report details of the transaction to both sides. These companies became known as Affiliate Marketing Networks (“AMN”) and served both sides of the process; which included the web sites sending customers (which became known as “publishers”), and the retailers receiving those customers (which became known as “merchants” or “advertisers”). Companies such as LinkShare, Commission Junction and recently eBay Enterprise are prime examples of AMNs.

The way the process works is that the AMN installs a special computer tracking code in the merchant's shopping cart that recognizes special link codes that the AMN provides to the affiliate publishers to use when they send a potential customer from their site to the merchant's on-line store. The code then tracks when a publisher's code is used, records the transactions made, and then reports this back to both sides of the transaction. The AMN also collects the commission from the merchant and sends the publisher its share based on whatever agreement the publisher has with the merchant. The AMN also offers publishers and merchants a type of clearing house as a method to interact with one another. This is done through the AMN's website where publishers can find merchants with whom to apply for an affiliate relationship and merchants can also find publishers that would like to do business with them.

Over the last decade the AMI and AMNs have become very well established and are doing tens of billions of dollars of business annually. Merchants have found that paying the publisher a commission (marketing fee) only after someone has made a purchase is by far more effective than spending tens of millions of dollars on conventional advertising to create and maintain corporate brand awareness with their prospective and current customers. AMI is simply the best return on investment (ROI) that can be achieved with a marketing dollar.

The next evolution in AMI came as a few pioneering companies launched what are now known as CashBack Shopping Malls (CBSM). The idea was to incentivize the shopper to use a specific website to find the merchants offering them an incentive. The CBSM included hundreds of merchants, just like a real shopping mall, so a shopper could easily shop with many stores, all under one roof.

As referenced above, in a traditional AMN model, the publisher placed ads on their site received from the AMN provider and received commissions on the subsequent sales that resulted. Therefore, all the publishers needed to do was place the merchant's ad on their website and then sit back and wait for their check from the AMN to arrive, based on how many people used that link and bought something.

However, the development of a CBSM required the publisher to become much more involved in the process. Offering a CBSM required the publisher to develop significant new technology as part of their web based platform that could allow visitors to register as a member of the CBSM and then track and share commission received based on which member bought what product from which merchant.

This new process involved the development of a member management system that assigned each registered member a unique identifier (ID) and stored that as a part of a membership directory. Then it required the creation of a system that could take the publisher's embedded link received from the AMN provider for each merchant code; then add to that a sub ID which contained the member's unique ID; which created a dynamic link unique to each member. These dynamic links were then substituted in the member's CBSM after they logged for each merchants' link available through the mall.

The final step in this process required the publisher develop a robust accounting system that could take each commission received on each transaction from the AMN from each merchant; look up the sub ID associated with it to identify which member made the purchase; and share that commission with the member as their CashBack. Websites such as Ebates, Fat Wallet, CashBack Saver and UPromise are prime examples of CBSMs.

All of the initial CBSM providers were business-to-consumer (B2C) business models. They had to brand themselves, attract potential customers to their site, and then sign them up as a member in order for the member to receive their CashBack. Due to the huge acceptance and success of CBSM, a few innovative companies decided to take this traditional B2C form of marketing and expand it to a business-to-business-to-consumer (B2B2C) business model, where they in turn could offer other companies with customers the ability to have its own CBSM under its own brand and offer CBSM services to its customers.

This involved the development of systems that could replicate a CBSM and then privately brand it for the CBSM provider's corporate clients. This dramatically lowered the cost of entry to offer a CBSM to the customers those companies served. These B2B2C CBSM models were first known as CashBack Rewards Malls (“CBRM”) and later as Merchant Funded Customer Loyalty Programs (“MFCLP”). Cartera, Very Important Relationships, Inc. and Corporate Perks are prime examples of these types of companies.

Previous to the creation of MFCLP, a company wishing to offer its customers an incentive for their loyalty had to pay for that incentive. For example, airlines offered frequent flyer miles to reward loyal customers for choosing their airlines to fly. These miles then accumulated and could later be redeemed for a free airline ticket. When redeemed the airline had to take an existing seat out of inventory they could have sold and give it to the loyal customer as their rewards, thus costing the airline the loss of revenue on the sale of that seat.

MFCLP changed all of that. They took an initial company with customers, allowed it to tap into the marketing budgets of the merchants in the mall, receive commissions from their customers shopping with that merchant, and convert that to a reward they could give to their customer for their loyalty. It didn't take long for companies to see the brilliance of this concept. Pretty soon most major airlines were offering MFCLP to their customers that converted the CashBack into miles in their frequent flyer programs; major banks and credit card providers started offering them as a CashBack reward to their customers; and large companies started using them as a customer loyalty program to reward customers with money that could only be spent back with them. Today, MFCLP is a multibillion dollar a year industry, but it is limited only to Internet-based transactions only.

### SUMMARY OF THE INVENTION

Due to the incredible developments and success of the MFCLP, there now exists the opportunity to expand this concept to off-line brick and mortar stores as well. Obviously, if merchants find it valuable to be able to pay a publisher for delivering customers to them and only pay them a commission if that person purchases something; why wouldn't they want to be able to have their off-line stores achieve the benefits?

While being able to expand CBSM and MFCLP to serve off-line brick and mortar merchants' stores would be a huge boon to retail industry, unfortunately this is not possible because the underlying AMI relies exclusively on connecting customers to the merchants together through the Internet. The dramatic expansion of the AMI that would occur if it were possible to include off-line brick and mortar stores has everyone in the industry searching for solution of how this could be accomplished; but to date, no one to date has been able to crack the code. The challenge in accomplishing this is that there is currently no technology and methodology available to do for off-line stores what is occurring through the on-line AMI.

The reason it works on the Internet is that the AMN provides the publisher with its own embedded tracking links that then direct its visitors to the participating merchant's Internet store. Since the AMN has also installed software code on the Internet shopping cart of the Merchant that then tracks and reports all transactions made through publishers' links, it can then fulfill the needed third party intermediary services to both side of program that allows this all to work.

A very important thing to note in this whole process is that the merchants would not be willing to pay a commission to someone unless they could prove that that person came to their store as a direct result of the publisher. In other words, the merchant needs proof at the moment of purchase that the customer come to it through the direct intervention of the publisher and would not have landed on their site at that moment on their own without the influence of the publisher. Merchants and payment processors, however, do not want to modify their existing infrastructure to provide the necessary confirmation that person came to their store as a direct result of the publisher. Moreover, most customers will not use a rewards system that costs them money, requires special equipment, is cumbersome, or time consuming. Without embedded tracking links and associated tracking software managed by AMN, how could this same thing be done in a real brink and mortar store?

Therefore, while there is a major need to transfer the AMI model from an exclusive on-line system to one that can perform the same functionalities in the brick and mortar world as well, no one has been able to provide a system to accomplish this. In order for such a system to work and be commercially accepted by payment processors, merchants and customers, it should effectively address each of the above stated issues that to date are unresolved.

The present invention provides a system, apparatus and method to facilitate the operation of the world's first off-line brick and mortar retail affiliate marketing system (the “OLAMS”). In some embodiments, it is composed of several independent systems that work together to duplicate the same results currently occurring through the Internet AMI.

For example, the present invention provides a computerized method for confirming a customer transaction by using a computer having a processor, a memory and a communications interface. A transaction data generated by a point-of-sale device physically located at a merchant is received via the communications interface. The transaction data includes a merchant identifier, a first customer identifier, a transaction amount and a first date/time. A customer location data generated by a customer mobile device physically located at the merchant is received via the communications interface. The customer location data includes a second customer identifier, a location information and a second date/time. A customer transaction confirmation is generated whenever the transaction data matches the customer location data, and one or more actions are performed based on the customer transaction confirmation.

In addition, the present invention provides an apparatus for confirming a customer transaction that includes a computer having a processor, a memory, a communications interface, and a computer program embodied on a non-transitory computer readable medium. When executed by the processor, the computer program causes the processor to receive the transaction data generated by the point-of-sale device via the communications interface, receive the customer location data generated by the customer mobile device via the communications interface, generate a customer transaction confirmation whenever the transaction data matches the customer location data, and perform one or more actions based on the customer transaction confirmation. The transaction data includes a merchant identifier, a first customer identifier, a transaction amount and a first date/time. The customer location data includes a second customer identifier, a location information and a second date/time.

Moreover, the present invention provides a system for confirming a customer transaction that includes a point-of-sale device physically located at a merchant, a customer mobile device physically located at the merchant, and a computer. The point-of-sale device generates a transaction data includes a merchant identifier, a first customer identifier, a transaction amount and a first date/time. The customer mobile device generates a customer location data includes a second customer identifier, a location information and a second date/time. The computer has a processor, a memory, a communications interface, and a computer program embodied on a non-transitory computer readable medium. When executed by the processor, the computer program causes the processor to receive the transaction data generated by the point-of-sale device via the communications interface, receive the customer location data generated by the customer mobile device via the communications interface, generate a customer transaction confirmation whenever the transaction data matches the customer location data, and perform one or more actions based on the customer transaction confirmation.

The foregoing method can be implemented using a computer program embodied on a computer readable medium that causes a processor or system controller to perform the foregoing steps.

### BRIEF DESCRIPTION OF THE DRAWINGS

For a more complete understanding of the features and advantages of the present invention, reference is now made to the detailed description of the invention along with the accompanying figures and in which:

FIG. 1 is a block diagram of a system in accordance with one embodiment of the present invention;

FIG. 2 is flow chart of a method in accordance with one embodiment of the present invention;

FIG. 3 is block diagram of various elements of an OLAMS in accordance with another embodiment of the present invention;

FIG. 4 is a process flow diagram from a payment processor in accordance with another embodiment of the present invention;

FIG. 5 is an overall process flow diagram in accordance with another embodiment of the present invention;

FIG. 6 is an overall process flow diagram in accordance with yet another embodiment of the present invention;

FIG. 7 is a process flow diagram from a transaction processor in accordance with another embodiment of the present invention; and

FIG. 8 is a block diagram of a system in accordance with yet another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Due to the incredible developments and success of the MFCLP, there now exists the opportunity to expand this concept to off-line brick and mortar stores as well. Obviously, if merchants find it valuable to be able to pay a publisher for delivering customers to them and only pay them a commission if that person purchases something; why wouldn't they want to be able to have their off-line stores achieve the benefits?

While being able to expand CBSM and MFCLP to serve off-line brick and mortar merchants' stores would be a huge boon to retail industry, unfortunately this is not possible because the underlying AMI relies exclusively on connecting customers to the merchants together through the Internet. The dramatic expansion of the AMI that would occur if it were possible to include off-line brick and mortar stores has everyone in the industry searching for solution of how this could be accomplished; but to date, no one to date has been able to crack the code. The challenge in accomplishing this is that there is currently no technology and methodology available to do for off-line stores what is occurring through the on-line AMI.

The reason it works on the Internet is that the AMN provides the publisher with its own embedded tracking links that then direct its visitors to the participating merchant's Internet store. Since the AMN has also installed software code on the Internet shopping cart of the Merchant that then tracks and reports all transactions made through publishers' links, it can then fulfill the needed third party intermediary services to both side of program that allows this all to work.

A very important thing to note in this whole process is that the merchants would not be willing to pay a commission to someone unless they could prove that that person came to their store as a direct result of the publisher. In other words, the merchant needs proof at the moment of purchase that the customer come to it through the direct intervention of the publisher and would not have landed on their site at that moment on their own without the influence of the publisher. Merchants and payment processors, however, do not want to modify their existing infrastructure to provide the necessary confirmation that person came to their store as a direct result of the publisher. Moreover, most customers will not use a rewards system that costs them money, requires special equipment, is cumbersome, or time consuming. Without embedded tracking links and associated tracking software managed by AMN, how could this same thing be done in a real brink and mortar store?

Therefore, while there is a major need to transfer the AMI model from an exclusive on-line system to one that can perform the same functionalities in the brick and mortar world as well, no one has been able to provide a system to accomplish this. In order for such a system to work and be commercially accepted by payment processors, merchants and customers, it should effectively address each of the above stated issues that to date are unresolved. Accordingly, the present invention provides a system, apparatus and method to facilitate the operation of the world's first off-line brick and mortar retail affiliate marketing system (the “OLAMS”).

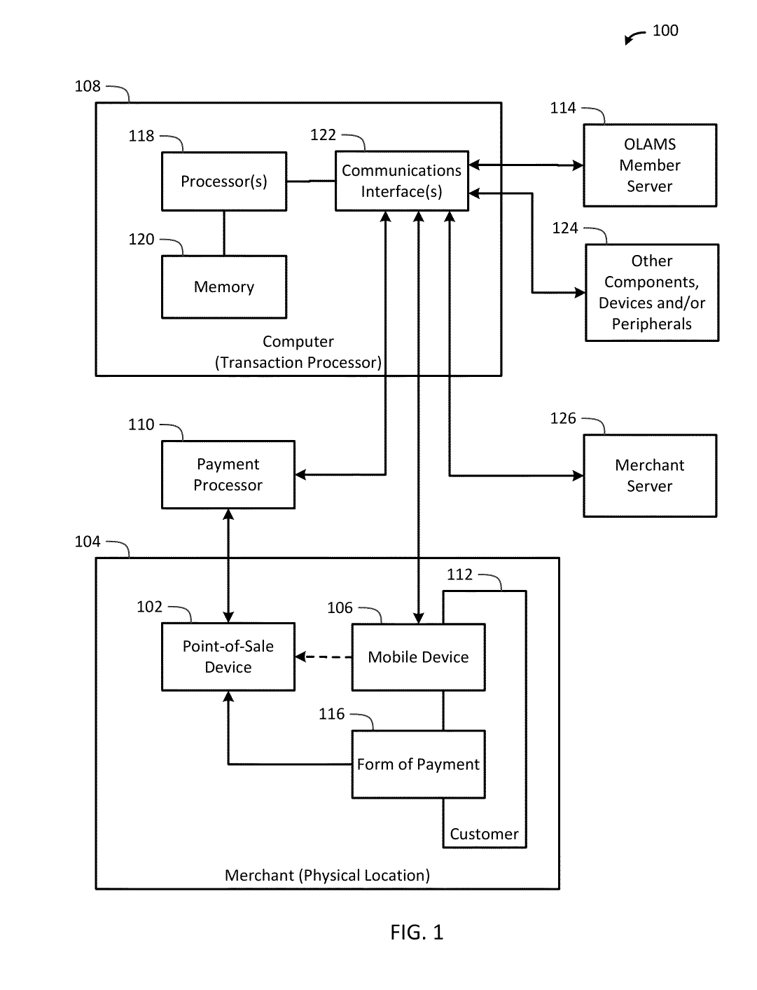

Now referring to FIG. 1, a block diagram of a system 100 for confirming an off-line (brick and mortar) customer transaction in accordance with one embodiment of the present invention is shown. The system 100 includes a point-of-sale device 102 physically located at a merchant 104, a customer mobile device 106 physically located at the merchant 104, and a computer (e.g., transaction processor) 108. The point-of-sale device 102 communicates with a payment processor 110, which in turn communicates with the computer 108. The point-of-sale device 102 can be any type of transaction completion device (e.g., cash register, credit/debt card machine, etc.). The customer mobile device 106 can be a mobile phone, a electronic token, an electronic tablet, an electronic wrist device, an electronic glasses or any other portable consumer device.

The customer mobile device 106 also communications with the server 108. Alternatively, the customer mobile device 106 can communicate with the point-of-sale device 102. The devices 102, 104, 106, 108 and 110 can communicate with one another over public networks, private networks, local networks, wide area networks, wired connections, wireless connections, or any other form of known or unknown communication mechanism using known or unknown protocols. As will be appreciated by those skilled in the art, the system 100 can include other devices and is not limited to the specific embodiments described herein.

The consumer or customer 112 joins, enrolls or registers with OLAMS via the computer 108, a members server 114 or other device or system communicably coupled with the communications interface 122 of the computer 108. Note that the consumer or customer 112 could join, enroll or register with OLAMS via the Internet, mobile device, e-mail, fax, paper application, or any other known or unknown process. The customer 112 is assigned a first customer identifier that is associated with one or more forms of payment 116 (e.g., a credit card, a stored value debit card, an electronic wallet, or any other known or unknown payment mechanism), which may or may not be provided by the OLAMS system operator or owner. The first customer identifier is stored or associated with the one or more forms of payment 116. The customer 112 also enters, loads or associates a second customer identifier with the customer mobile device 106 using an application or other means. Alternatively, the customer mobile device 106 can be provided to the customer 112 by the OLAMS. The first customer identifier and the second customer identifier can be the same or different as long as the computer 108 can determine that the two customer identifiers are associated with the same customer 112. Note that the customer 112 will generally be an individual, but the system 100 will also work if the customer is an entity, individual, group, family, etc. The customer mobile device 106 has an application, component or ability to confirm that the customer 112 is at a given location at a given date/time.

The customer 112 enters the off-line (brick and mortar) store or location of the merchant 104 and selects or picks up the items or services to be purchased. When the customer 112 checks out, he or she provides the merchant 104 with any desired form of payment 116 that is both associated with the customer 112 by the computer 108 via the first customer identifier and accepted by the merchant 104. The point-of-sale device 102 generates a transaction data includes a merchant identifier, a first customer identifier, a transaction amount, a first date/time and any other information or data required or desired by the payment processor 110, the merchant 104 or the computer 108.

Before, during or after check out, but while physically at the merchant 104, the customer 112 causes the customer mobile device 106 to notify the computer 108 that the customer 112 is at the merchant's location. The notification or customer location data includes the second customer identifier, a location information and a second date/time. The customer 112 may input or select additional information that is included in the customer location data. This can be performed by an application provided by the OLAMS operator and downloaded to the customer mobile device 106 via any known or unknown process. The application can also be a module or component of another application running on the customer mobile device 106. Alternatively, the application could provide periodic or continuously location information to the computer depending on the customer's power setting and privacy profile. Moreover, the location information can be obtained from a navigation application running on the customer mobile device 106 or a navigation system communicably coupled to the customer mobile device 106. As previously described, the customer mobile device 106 can provide the information to the point-of-sale device 102.

The computer 108 includes one or more processors 118, a memory 120 and one or more communications interfaces 122. As appreciated by those skilled the art, the computer 108 can be multiple computers, multiple processors and may include many other components, devices and/or peripherals 124. Moreover, the computer 108 can be implemented in a distributed architecture at multiple geographic locations. The computer 108 also includes a computer program embodied on a non-transitory computer readable medium (not shown) that when executed by the processor 118 causes the processor 118 to perform the method of the present invention. As will be described below, the computer 108 is communicably coupled to one or more merchant servers 126.

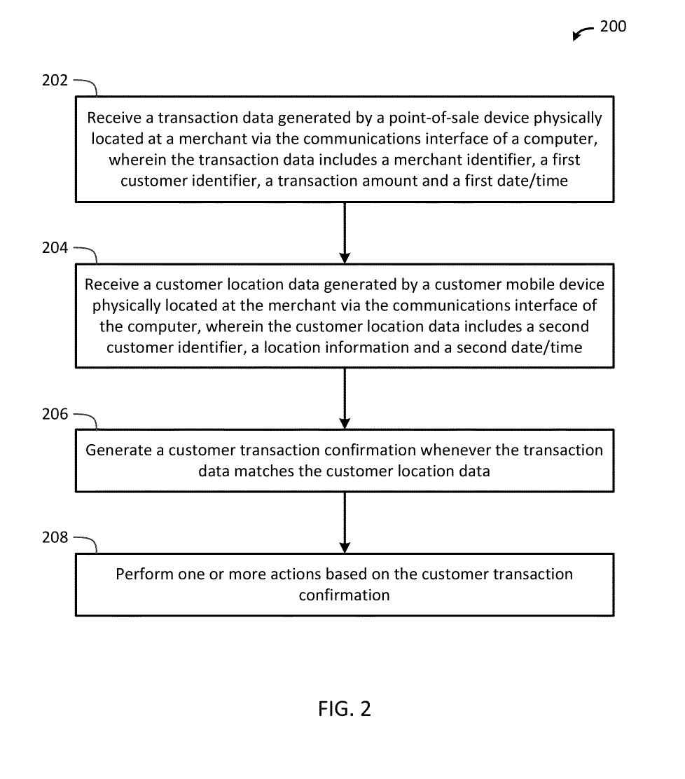

Referring now to FIG. 2, a flow chart illustrating the method 200 in accordance with one embodiment of the present invention is shown. The computer's processor 118 receives the transaction data generated by the point-of-sale device via the communications interface in block 202. The transaction data includes a merchant identifier, a first customer identifier, a transaction amount and a first date/time. The computer's processor 118 receives the customer location data generated by the customer mobile device via the communications interface in block 204. The customer location data includes a second customer identifier, a location information and a second date/time. The computer's processor 118 generates a customer transaction confirmation whenever the transaction data matches the customer location data in block 206, and performs one or more actions based on the customer transaction confirmation in block 208.

As previously described, the customer mobile device 106 can alternatively transmit the customer location data to the point-of-sale device 102 which receives the customer location data and transmits the customer location data to the communications interface 122. The customer location data can be sent separately or combined together and sent in one communication. In this case, the data is forwarded to the computer 108 once the transaction is approved and/or finalized. In the event the transaction is later voided (e.g., returned item, etc.) or determined to be fraudulent, the payment processor 110 will notify the computer 108 so that proper action can be taken.

The processor 118 stores the transaction data, the customer location data and the customer transaction confirmation in one or more databases (local or remote) communicably coupled to the computer 108. The computer 108 will then attempt to match customer location data with transaction data by merchant 104 and by customer 112. Preferably, the transaction data matches the customer location data whenever (1) the merchant identifier and the location information confirm that the customer mobile device 106 was physically located at the merchant 104, (2) the first customer identifier and the second customer identifier correspond to the same customer 112, and (3) the first date/time is within a specified time period of the second date/time. Note that other criteria can be used. The processor 118 can generate the customer transaction confirmation in a real time, near-real time or a batch process.

The computer 108 or other systems can then perform the one or more actions based on the match (block 208). One example of such an action is calculating a commission due from one or more merchants based on the customer transaction confirmation, and generating an invoice for the one or more merchants based on the commission due. Another example of such an action is calculating a reward due to one or more customers based on the customer transaction confirmations, and providing the reward to the one or more customers. The reward can be a cash back, an award pursuant to a customer loyalty program, one or more points, or a combination thereof. Yet another example of such an action is generating one or more reports based on the customer transaction confirmations.

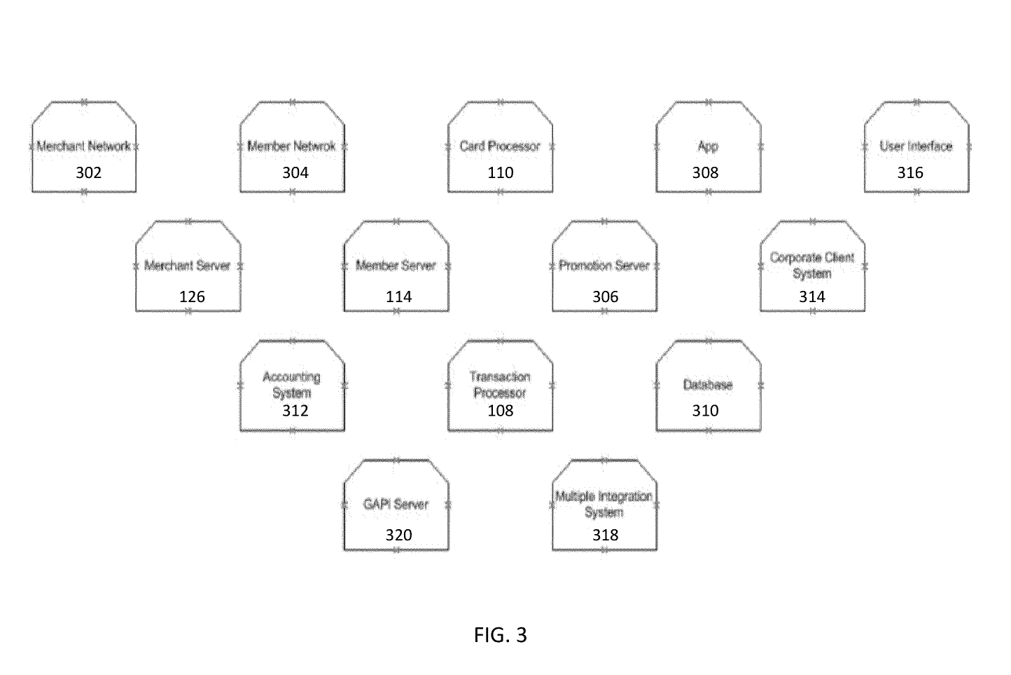

In some embodiments, it is composed of several independent systems that work together to duplicate the same results currently occurring through the Internet AMI. For example, FIG. 3 shows various elements in accordance with one embodiment of the present invention:
302—A merchant network (“Merchant Network”) comprised of merchants wishing to participate in the OLAMS (“Merchants”);
126—A Merchant management server designed to manage and communicate with the Merchants of the OLAMS (“Merchant Server”);
304—A members network (“Members Network”) composed of members wishing to benefit from membership in the OLAMS (“Member”) in whatever form it is presented to them (i.e., CashBack Reward, Customer Loyalty program, Points, etc.);
114—A Member management server designed to manage and communicate with the Members of the OLAMS (“Member Server”);
306—A Hot Deals and Promotion server designed to manage promotions offered from the Merchants to Members (“Promotions Server”);
110—A payment processor that performs the payment transaction processing associated with a linked credit card or stored value debit card “Card” used by Members with Merchants when making purchases;
308—A geo-targeted phone application (“App”) that identifies the date, time and location of a Card Holder when a purchase is made and transmits it to the Transaction Processor;
310—A system that assigns unique IDs to both Merchants, Members, and Apps and stores that information in a database for later retrieval (“Database”);
108—A transaction processor that can ingest data from the Cards and APPs that determine which Members bought what from which Merchants on what dates and then matches that up with data received from the Apps (“Transaction Processor”);
312—An accounting system that can bill Merchants on commissions due from Member purchases and then pays Members a portion of that as their Rewards (“Accounting System”);
314—A method for managing corporate clients (“Corporate Clients”) wishing to offer a MFCLP which utilizes Off-line merchants to their customer (“Corporate Client System”);
316—A system that mergers all of the above processes together and presents them as an operating business model to Merchants, Corporate Clients, and Members (“User Interface”);
318—The development of a system which will allow for integration of the OLAMS with other external systems so it can be offered to existing CBSM and MFCLP providers to enhance their product offerings (“Multiple Integration System”); and
320—A central brain server designed to gather all application program interface (“API”) requests coming from other servers in the OLAMS system (“GAPI Server”).

This embodiment of the present invention combines the foregoing elements into a platform that integrates all of these features to create the OLAMS. The actual steps to accomplish this are further explained below.

The first step in creating the OLAMS is to create a relationship with one or more Payment processors that will in turn supply to the OLAMS the transactional information from registered Members' Cards in the program. This data will contain a breakout of each transaction made using each Member's Card and will include the date, time, merchant ID, and transaction amount of each transaction.

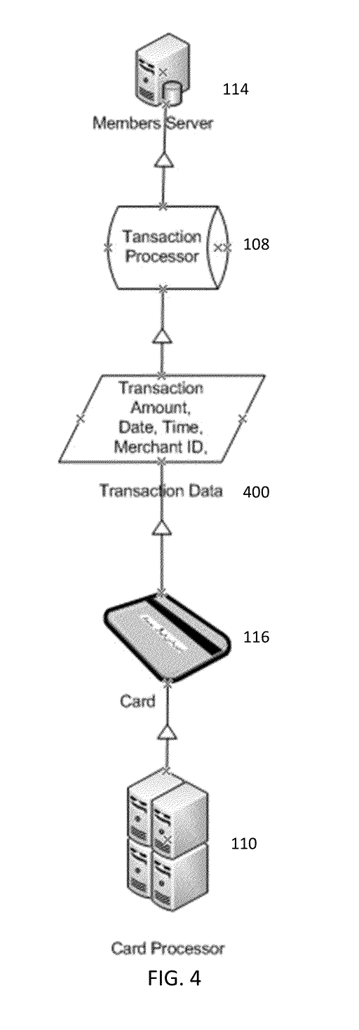

As shown in FIG. 4, the transaction data 400 received will be ingested through the Transaction Processor 108, and any transactions bearing a participating Merchants' IDs will be identified and then stored with the other transaction information required in the corresponding Member's account within the Database 114.

Merchants that wish to participate in the OLAMS, like they currently do with AMNs, will enter into agreements with the OLAMS provider to pay a certain commission or fee when a shopper who is a member of the system shops with them and also identifies that they have chosen to come to the Merchant's store as a direct result of being a member in the OLAMS. This will be accomplished through the use of the Card and App, which will further be explained below.

A member wishing to participate in the OLAMS will need to register for membership in the program and also apply for the OLAMS' credit and or stored value Debit Card. They will also need to install the App on their cell phone.

The Member User Interface will communicate with Members which stores are participating in the System. This will also be available to them through their App.

If a Member decides to shop with a participating Merchant in the OLAMS, they will go to that Merchant's store directly and then make whatever purchases they desire. In order to prove that they are members in the program, and also intentionally came to the store as a direct result of the OLAMS, they will pay for their purchase using their OLAMS Card. Additionally, they will turn on their App at the store at the time of purchase and click on a bottom on the app that will trigger the geo-targeting capabilities to identify where they are and record that information along with the current date and time.

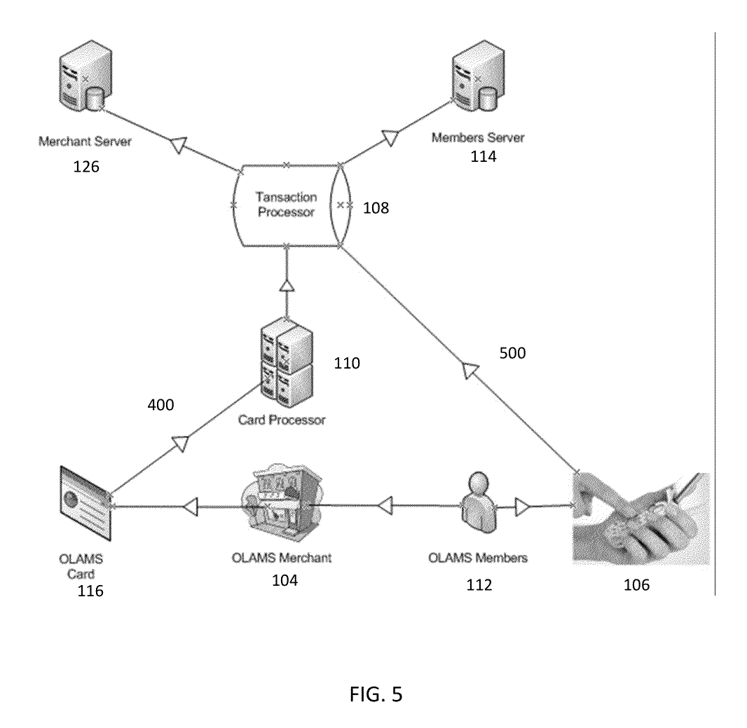

As shown in FIG. 5, the App on the customer mobile device 106 will then communicate through the Internet with the Transaction Processor 108 and forward the recorded information (location information 500) to it. The Transaction Processor 108 will then store that information in the Member's account to be matched up with transaction information 400 to confirm both events have occurred.

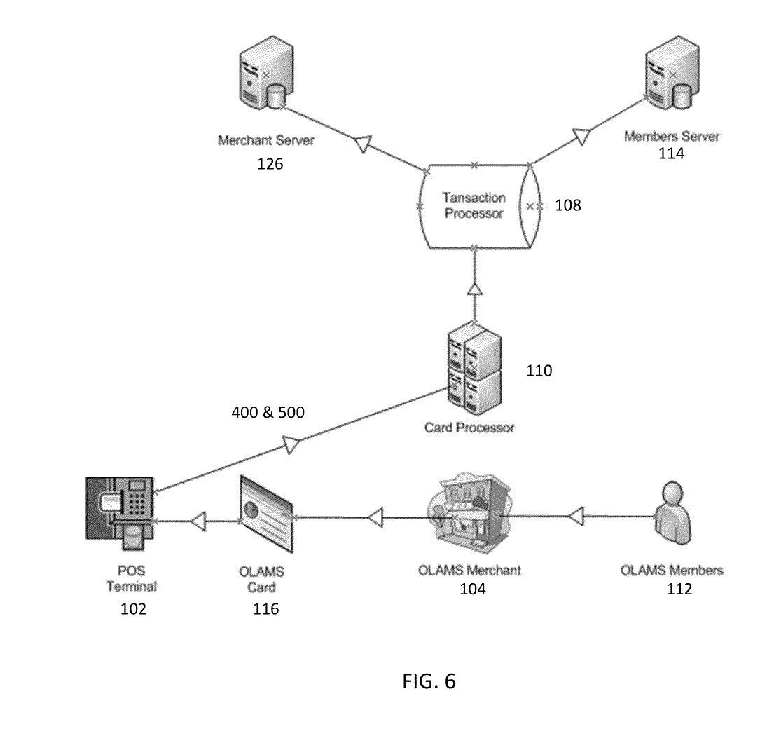

As shown in FIG. 6, another possible embodiment of this process could replace the geo-targeting feature of the App with near field communication enabling the App to communicate directly with the Merchant's POS terminal 102, which in turn would pass the required information (transaction data 400 and location information 500) through the POS 102 to the Payment processor 110, thus creating the same end result.

The Transaction Processor 108 will then create an accounting for a specific period and run several reports. The first report will look in each Member's account at all qualifying Merchant transactions from participating Merchants. It will then query the locations, times and dates received from the App to cross match those to any participating Merchant transactions. Those that match will then be stored in a confirmed transaction report (“Confirmed Transactions”). This report will contain both the data received from the Payment processor and the information received by the App, thus confirming that this Member shopped with that Merchant and clicked on their App while in the Merchant's store.

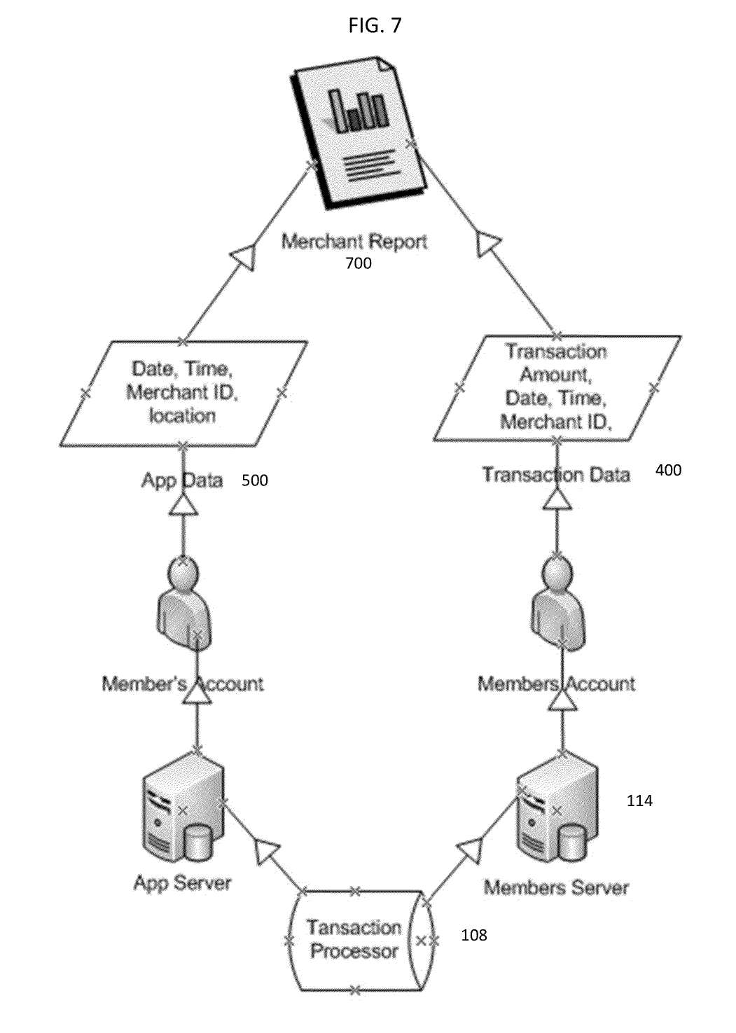

As shown in FIG. 7, the way the OLAMS will prove to a Merchant that a Member intentional came to their store with the intent to receive a reward through the OLAMS is the Transaction Process will take the Confirmed Transaction Reports and compile a separate report 700 for each Merchant detailing each confirmed transaction and the appropriate commission due (“Merchant Report”). This report will then be sent to the Merchant along with an Invoice for the commission due under their Agreement with the OLAMS.

In another embodiment of this same process, the Merchant Report 700 would be sent electronically to the Merchant and the commissions due would then be debited from a pre-established Escrow bank account set up by the Merchant to pay any commission amounts due.

Once the OLAMS is fully developed, it can be used by entities that would normally sponsor or offer a CBSM or MFCLP direct to their customers (the B2C side of this business model). This would immediately open up their existing programs to allow its members to not only receive rewards for their on-line purchases, but also the off-line ones as well.

These Corporate Clients of the OLAMS would immediate benefit from their affiliation with the OLAMS and generate an entirely new stream of income to which they did not currently have access. Therefore the Invention would also include a Multiple Integration System Technology (“M.I.S.T.”) component which would enable the User Interface to fully interact with independent third party platforms.

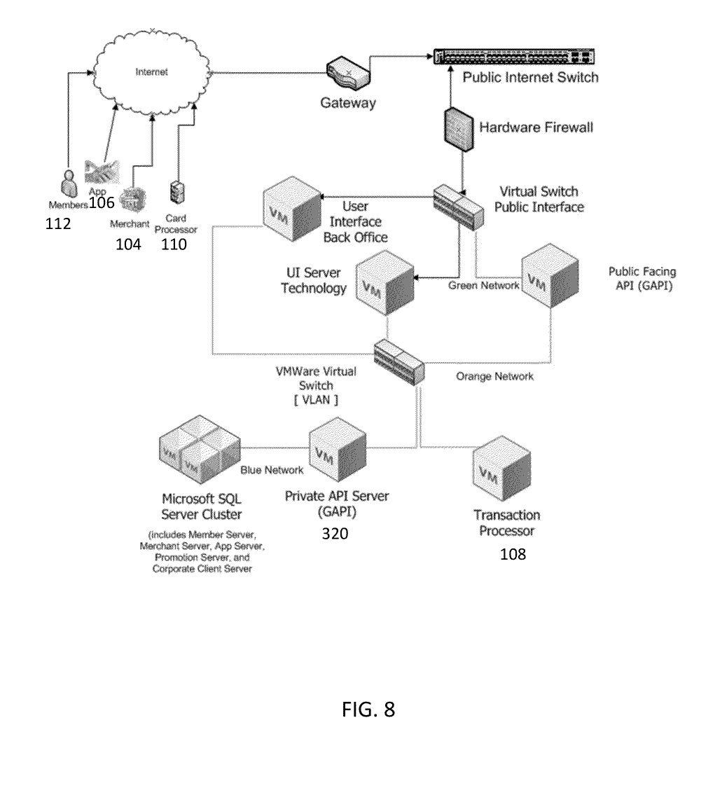

The M.I.S.T. platform will be designed so each element of the OLAMS system (see FIG. 3) is a completely independent, stand alone, plug and play component operating on its own server (see FIG. 8). In one embodiment of the Invention, all communication within the M.I.S.T platform will be A.P.I. based web services designed to allow a free flow of information from one system or server to the next. The User Interfaces will also be API based so each UI in the OLAMS system can be designed to be a standalone independent system housed on any server on the Internet and still actively participate within the OLAMS platform.

In order to allow each system to freely communicate with the next, a GAPI Server will be built to handle all incoming API requests from each element on the OLAMS system. The GAPI Server will then gather all API requests and play traffic cop with them to ensure they safely reach the desired location.

This M.I.S.T. element of the Invention will allow the OLAMS platform to have ultimate flexibility so it can quickly be modified to provide each Corporate Client exactly the type of service and interface they desire. It is, in essence, a rapid deploy tool kit designed to allow the M.I.S.T platform to morph and conform as needed in a fraction of the time of traditional development.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications, patents and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A computerized method for confirming a customer transaction comprising the steps of:
providing a computer having a processor, a memory and a communications interface;
receiving a transaction data generated by a point-of-sale device physically located at a merchant via the communications interface, the transaction data comprising a merchant identifier, a first customer identifier, a transaction amount and a first date/time;
receiving a customer location data generated by a customer mobile device physically located at the merchant via the communications interface, the customer location data comprising a second customer identifier, a location information and a second date/time;
generating a customer transaction confirmation whenever the transaction data matches the customer location data; and
performing one or more actions based on the customer transaction confirmation.

2. The method as recited in claim 1, wherein the step of receiving the customer location data generated by the customer mobile device physically located at the merchant via the communications interface comprises the steps of:
receiving the customer location data generated by the customer mobile device at the point-of-sale device; and
transmitting the customer location data to the communications interface.

3. The method as recited in claim 2, further comprising the step of combining the customer location data with the transaction data.

4. The method as recited in claim 1, further comprising the steps of:
generating the customer location data using an application running on the customer mobile device or a navigation system communicably coupled to the customer mobile device; and
transmitting the customer location data to the communications interface.

5. The method as recited in claim 1, wherein the step of generating the customer transaction confirmation comprises a real time or near-real time.

6. The method as recited in claim 1, wherein the transaction data matches the customer location data further whenever (1) the merchant identifier and the location information confirm that the customer mobile device was physically located at the merchant, (2) the first customer identifier and the second customer identifier correspond to a customer, and (3) the first date/time is within a specified time period of the second date/time.

7. The method as recited in claim 1, wherein the step of performing one or more actions based on the customer transaction confirmation comprises the steps of:
calculating a commission due from one or more merchants based on the customer transaction confirmation; and
generating an invoice for the one or more merchants based on the commission due.

8. The method as recited in claim 1, wherein the step of performing one or more actions based on the customer transaction confirmation comprises the steps of:
calculating a reward due to one or more customers based on the customer transaction confirmations;
providing the reward to the one or more customers; and
the reward comprises a cash back, an award pursuant to a customer loyalty program, one or more points, or a combination thereof.

9. The method as recited in claim 1, wherein:
the first customer identifier is stored or associated with a credit card, a stored value debit card or an electronic wallet; and
the customer mobile device comprises a mobile phone, a electronic token, an electronic tablet, an electronic wrist device, or an electronic glasses

10. An apparatus for confirming a customer transaction comprising:
a computer having a processor, a memory and a communications interface; and
a computer program embodied on a non-transitory computer readable medium that when executed by the processor causes the processor to:
receive a transaction data generated by a point-of-sale device physically located at a merchant via the communications interface, the transaction data comprising a merchant identifier, a first customer identifier, a transaction amount and a first date/time,
receive a customer location data generated by a customer mobile device physically located at the merchant via the communications interface, the customer location data comprising a second customer identifier, a location information and a second date/time,
generate a customer transaction confirmation whenever the transaction data matches the customer location data, and
perform one or more actions based on the customer transaction confirmation.

11. The apparatus as recited in claim 10, wherein the processor receives the customer location data generated by the customer mobile device physically located at the merchant via the communications interface by:
receiving the customer location data generated by the customer mobile device at the point-of-sale device; and
transmitting the customer location data to the communications interface.

12. The apparatus as recited in claim 10, wherein an application running on the customer mobile device or a navigation system communicably coupled to the customer mobile device generates the customer location data and the customer mobile device transmits the customer location data to the communications interface.

13. The apparatus as recited in claim 10, wherein the transaction data matches the customer location data further whenever (1) the merchant identifier and the location information confirm that the customer mobile device was physically located at the merchant, (2) the first customer identifier and the second customer identifier correspond to a customer, and (3) the first date/time is within a specified time period of the second date/time.

14. The apparatus as recited in claim 10, wherein one or more actions comprise:
calculating a commission due from one or more merchants based on the customer transaction confirmation; and
generating an invoice for the one or more merchants based on the commission due.

15. The apparatus as recited in claim 10, wherein one or more actions comprise:
calculating a reward due to one or more customers based on the customer transaction confirmations;
providing the reward to the one or more customers; and
the reward comprises a cash back, an award pursuant to a customer loyalty program, one or more points, or a combination thereof.

16. The apparatus as recited in claim 10, wherein:
the first customer identifier is stored or associated with a credit card, a stored value debit card or an electronic wallet; and
the customer mobile device comprises a mobile phone, a electronic token, an electronic tablet, an electronic wrist device, or an electronic glasses.

17. A system for confirming a customer transaction comprising:
a point-of-sale device physically located at a merchant that generates a transaction data comprising a merchant identifier, a first customer identifier, a transaction amount and a first date/time;
a customer mobile device physically located at the merchant that generates a customer location data comprising a second customer identifier, a location information and a second date/time;
a computer having a processor, a memory and a communications interface; and
a computer program embodied on a non-transitory computer readable medium that when executed by the processor causes the processor to:
receive the transaction data generated by the point-of-sale device via the communications interface,
receive the customer location data generated by the customer mobile device via the communications interface,
generate a customer transaction confirmation whenever the transaction data matches the customer location data, and
perform one or more actions based on the customer transaction confirmation.

18. The system as recited in claim 17, wherein:
the customer mobile device transmits the customer location data to the point-of-sale device; and
the point-of-sale device receives the customer location data and transmits the customer location data to the communications interface.

19. The system as recited in claim 17, wherein the customer mobile device transmits the customer location data to the communications interface.

20. The system as recited in claim 17, wherein the location information is obtained from a navigation application running on the customer mobile device or a navigation system communicably coupled to the customer mobile device.

21. The system as recited in claim 17, wherein the transaction data matches the customer location data further whenever (1) the merchant identifier and the location information confirm that the customer mobile device was physically located at the merchant, (2) the first customer identifier and the second customer identifier correspond to a customer, and (3) the first date/time is within a specified time period of the second date/time.

22. The system as recited in claim 17, wherein one or more actions comprise:
calculating a commission due from one or more merchants based on the customer transaction confirmation; and
generating an invoice for the one or more merchants based on the commission due.

23. The system as recited in claim 17, wherein one or more actions comprise:
calculating a reward due to one or more customers based on the customer transaction confirmations;
providing the reward to the one or more customers; and
the reward comprises a cash back, an award pursuant to a customer loyalty program, one or more points, or a combination thereof.

24. The system as recited in claim 17, wherein:
the first customer identifier is stored or associated with a credit card, a stored value debit card or an electronic wallet; and
the customer mobile device comprises a mobile phone, a electronic token, an electronic tablet, an electronic wrist device, or an electronic glasses.
